(19) United States
(12) Patent Application Publication
(10) Pub. No.: US 2015/0210410 A1
(43) Pub. Date: Jul. 30, 2015

(54) AUTOMATIC PREPARATION SYSTEM

(71) Applicants: KABUSHIKI KAISHA YASKAWA DENKI, Kitakyushu-shi (JP); NATIONAL INSTITUTE OF ADVANCED INDUSTRIAL SCIENCE AND TECHNOLOGY, Tokyo (JP)

(72) Inventors: Makoto UMENO, Fukuoka (JP); Kohei MIYAUCHI, Fukuoka (JP); Takashi SUYAMA, Fukuoka (JP); Toru NATSUME, Tokyo (JP)

(73) Assignees: KABUSHIKI KAISHA YASKAWA DENKI, Kitakyushu-shi (JP); NATIONAL INSTITUTE OF ADVANCED INDUSTRIAL SCIENCE AND TECHNOLOGY, Tokyo (JP)

(21) Appl. No.: 14/679,003

(22) Filed: Apr. 5, 2015

Related U.S. Application Data
(63) Continuation of application No. PCT/JP2012/076035, filed on Oct. 5, 2012.

(51) Int. Cl. B65B 3/00; A61J 1/20; A61J 1/16

(52) U.S. Cl. CPC B65B 3/003; A61J 1/16; A61J 1/2096; A61J 1/201

(57) ABSTRACT

An automatic preparation system according to embodiments includes a work table, a robot, and a jig. The robot is disposed near the work table and includes a plurality of arms. The jig is provided on the work table and rotatably holds a syringe. The robot, after taking out the syringe from a syringe storage case and attaching the syringe to the jig, operates the arms in a cooperative manner to perform a preparation of a medication using the syringe.

### CROSS-REFERENCE TO RELATED APPLICATION

This application is a continuation of PCT international application Ser. No. PCT/JP2012/076035 filed on Oct. 5, 2012 which designates the United States, the entire contents of which are incorporated herein by reference.

### FIELD

The embodiment discussed herein is directed to an automatic preparation system.

### BACKGROUND

Japanese Patent Application Laid-open No. 2003-095205 discloses a medication dispensing device that divides a tablet into pieces by using a cutter and separately dispenses a divided piece of the tablet.

### SUMMARY

An automatic preparation system according to an aspect of embodiment includes a work table, a robot, and a jig. The robot is disposed near the work table and includes a plurality of arms. The jig is provided on the work table and rotatably holds a syringe. The robot, after taking out the syringe from a syringe storage case and attaching the syringe to the jig, operates the arms in a cooperative manner to perform a preparation of a medication using the syringe.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1A is a schematic perspective view of an automatic preparation system.

FIG. 1B is a diagram schematically illustrating a simplified configuration of a robot included in the automatic preparation system.

FIG. 2A is a schematic plan view of the automatic preparation system according to an embodiment.

FIG. 2B is a schematic side view of the automatic preparation system according to the embodiment.

FIG. 3A is a schematic side view of a syringe holding jig.

FIG. 3B is a schematic front view of the syringe holding jig.

FIG. 4A is an enlarged schematic side view of a periphery of a holding unit.

FIG. 4B is an enlarged schematic plan view of the periphery of the holding unit.

FIG. 5 is a schematic perspective view of a needle storage case.

FIG. 6A is a schematic perspective view of a needle temporary stand.

FIG. 6B is a schematic side view of the needle temporary stand.

FIG. 7A is a schematic plan view of end effectors.

FIG. 7B is a schematic perspective view of an end effector.

FIG. 8 is a flowchart illustrating a series of preparation operations performed by the automatic preparation system.

FIGS. 9A and 9B are the diagrams illustrating how an unpacking operation is performed.

FIGS. 10A and 10B are the diagrams illustrating how a needle installation operation is performed.

FIG. 11 is a diagram illustrating how a first liquid drawing operation is performed.

FIGS. 12A and 12B are the diagrams illustrating an inversion operation.

FIG. 13 is a diagram illustrating how a first injection and mixing operation is performed.

### DESCRIPTION OF EMBODIMENT

The following fully describes an embodiment of an automatic preparation system disclosed in the present application with reference to the accompanying drawings. The following embodiment is not intended to limit the scope of the present invention.

1. Entire Configuration of the Automatic Preparation System

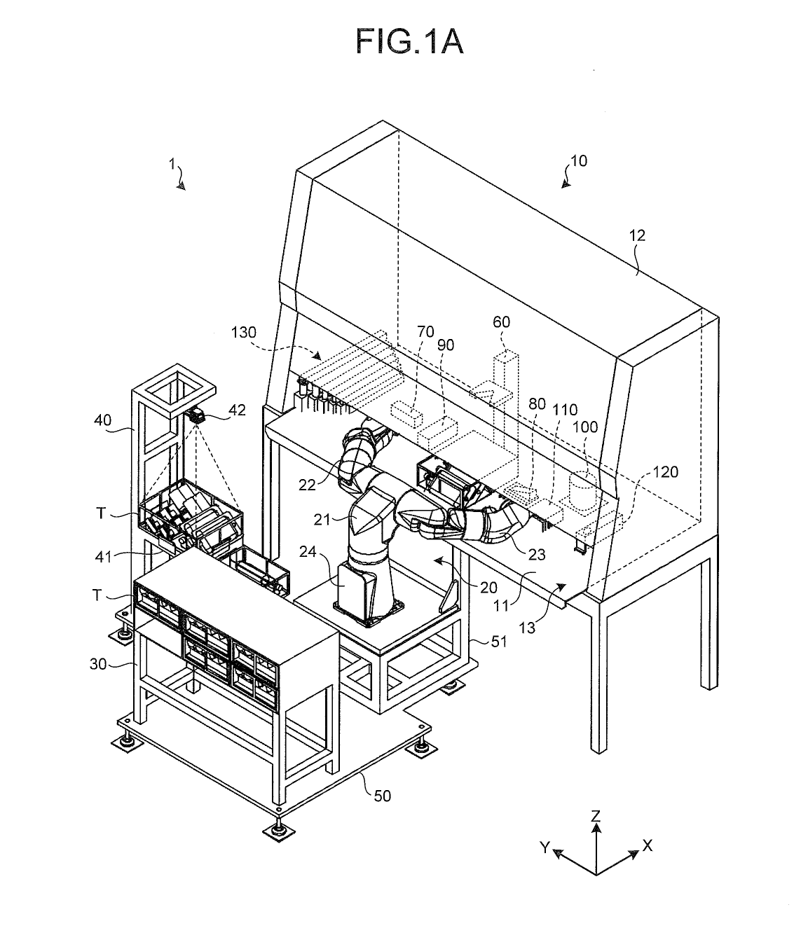

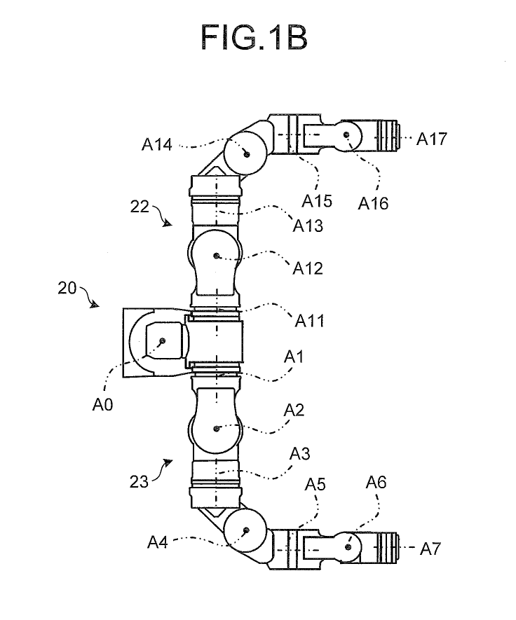

FIG. 1A is a schematic perspective view of the automatic preparation system according to the present embodiment. In the drawings to be referred to in the following description, an X-axis direction, a Y-axis direction, and a Z-axis direction are defined that are perpendicular to one another in order to clarify the positional relation, and the positive direction of the Z-axis is defined as the upward direction of the vertical direction.

As illustrated in FIG. 1A, an automatic preparation system 1 according to the present embodiment includes a safety cabinet 10, a robot 20, a tray depository 30, and an image-capturing stage 40.

In the automatic preparation system 1, the robot 20 takes out a tray T that stores medications to be prepared from the tray depository 30 and conveys the tray T that has been taken out to the safety cabinet 10. In the automatic preparation system 1, the robot 20 performs preparation operations of the medications stored in the tray T in the safety cabinet 10, and carries the tray T storing medications after preparation out of the safety cabinet 10 back to the tray depository 30.

As described above, the automatic preparation system 1 is a system that automatically performs a series of preparation operations from an operation of taking out medications to an operation of dispensing the medications after preparation. The automatic preparation system 1 can be applied to preparation operations of various medications. In particular, the automatic preparation system 1 may preferably be applied to the preparation operations of medications such as anti-cancer drugs that are dangerous to those who prepare the medications. The following describes constituent elements of the automatic preparation system 1.

The safety cabinet 10 is a work table with a case 12 covering an upper space of a top board 11. The case 12 is provided with a front opening 13 having a height enough for an ordinary human arm to be put in and out. On the top board 11, various devices are disposed that are used for the preparation operations of medications. Specifically, disposed on the top board 11 are a syringe holding jig 60, a needle storage case 70, a needle temporary stand 80, a vial temporary stand 90, a disposal bottle 100, a syringe storage case 110, a weight scale 120, and a spare syringe storage case 130.

The syringe holding jig 60 rotatably holds a syringe used for preparation operations. The jig 60 corresponds to an example of means for rotatably holding a syringe. The needle storage case 70 stores therein a plurality of unopened needles (hereinafter simply referred to as “needles”). The needle temporary stand 80 is a stand on which an unpacked needle is temporarily placed. The vial temporary stand 90 is a stand on which a vial taken out from the tray T is temporarily placed. The disposal bottle 100 is a place where used syringes and needles are disposed of. The syringe storage case 110 stores therein a plurality of syringes that are different in size. The weight scale 120 is used to measure the weight of the medications after preparation. The spare syringe storage case 130 is a place where spare syringes are stored with the syringes being sorted by size. These devices will be fully described later.

The safety cabinet 10 is configured to keep the work space surrounded by the top board 11 and the case 12 in a negative pressure situation by discharging air through an air filter such as a high efficiency particulate air (HEPA) filter so that toxic substances occurring in the preparation operations will not spread out to the outside of the safety cabinet 10.

Although not illustrated in FIG. 1A, other devices such as a recording camera and a shower pump dispenser bottle are disposed in the safety cabinet 10.

The robot 20 is disposed near the safety cabinet 10. Specifically, the robot 20 is disposed in front of the front opening 13 of the safety cabinet 10.

The robot 20 is what is called a dual arm robot with a left arm 22 and a right arm 23 installed on the respective shoulders of a body 21. The left arm 22 and the right arm 23 are multiaxial robots each including a plurality of joint axes. The body 21 of the robot 20 is connected to a base 24 via an actuator (not illustrated), and can swing about the rotor shaft of the actuator.

Rotor shafts of actuators is more specifically described with reference to FIG. 1B. FIG. 1B is a diagram schematically illustrating a simplified configuration of the robot included in the automatic preparation system. In FIG. 1B, end effectors are not illustrated.

As illustrated in FIG. 1B, the body 21 and the base 24 are connected with each other such that they can relatively rotate about a rotor shaft A0. The rotor shaft A0 is substantially perpendicular to a surface on which the base 24 is installed.

The left arm 22 is rotatably connected to the body 21 about a rotor shaft A11, and the right arm 23 is rotatably connected to the body 21 about a rotor shaft A1. The rotor shaft A1 and the rotor shaft A11 are perpendicular to the rotor shaft A0.

As described above, the left arm 22 and the right arm 23 are multiaxial robots each including a plurality of joint axes. The left arm 22 and the right arm 23 each include seven rotor shafts (joint axes) including the rotor shaft A1 and the rotor shaft A11, and include seven joints that can rotate about the respective rotor shafts.

The left arm 22 is configured such that a rotor shaft A12 is perpendicular to the rotor shaft A11, a rotor shaft A13 is perpendicular to the rotor shaft A12, a rotor shaft A14 is perpendicular to the rotor shaft A13, a rotor shaft A15 is perpendicular to the rotor shaft A14, a rotor shaft A16 is perpendicular to the rotor shaft A15, and a rotor shaft A17 is perpendicular to the rotor shaft A16. The right arm 23 is configured such that a rotor shaft A2 is perpendicular to the rotor shaft A1, a rotor shaft A3 is perpendicular to the rotor shaft A2, a rotor shaft A4 is perpendicular to the rotor shaft A3, a rotor shaft A5 is perpendicular to the rotor shaft A4, a rotor shaft A6 is perpendicular to the rotor shaft A5, and a rotor shaft A7 is perpendicular to the rotor shaft A6.

The word “perpendicular” above does not necessarily require precise perpendicularity in the mathematical sense, and substantial tolerances and errors are allowed.

The left arm 22 and the right arm 23 can enter into the safety cabinet 10 through the front opening 13. In this case, the rotor shaft A1 and the rotor shaft A11 are fixed or their rotation ranges are largely limited so that the left arm 22 and the right arm 23 will not touch the surrounding edge of the front opening 13. The left arm 22 and the right arm 23, however, still have six degrees of freedom, the rotor shafts A12 to A17 and the rotor shafts A2 to A7, whereby the limitation on the position and posture of the left arm 22 and the right arm 23 inside the safety cabinet 10 is mitigated.

End effectors are provided at the leading ends of the left arm 22 and the right arm 23 to grasp instruments such as a syringe and a vial. The robot 20 puts the end effectors into the work space of the safety cabinet 10 through the front opening 13 of the safety cabinet 10, and performs preparation operations of medications by moving the left arm 22, the right arm 23, and the end effectors in a cooperative manner in the work space.

The configuration of the end effectors and the nature of the preparation operations performed by the robot 20 will be described later.

The tray depository 30 is disposed at the rear of the robot 20, specifically, disposed at a side opposite to the safety cabinet 10 over the robot 20. In the tray depository 30, a plurality of trays T are stored.

Each tray T stores therein all the medications required for one cycle of the preparation operations. In the present embodiment, each tray T stores therein a plurality of vials each containing a different medication, and intravenous solution. Barcodes are attached to the respective trays T to distinguish a tray T from the other.

The image-capturing stage 40 is disposed at a rear side of the robot 20, and, in FIG. 1A, disposed at the rear-left side of the robot 20. The image-capturing stage 40 includes a temporary stand 41 for a tray T and an image-capturing unit 42 disposed above the temporary stand 41.

Before the preparation operations performed by the robot 20, a precheck operation is performed on the image-capturing stand 40 to check whether a right tray T is selected by reading the barcode of the tray T put on the temporary stand 41 by using the image-capturing unit 42 such as a charge coupled device (CCD) camera. The nature of the precheck operation will be described later.

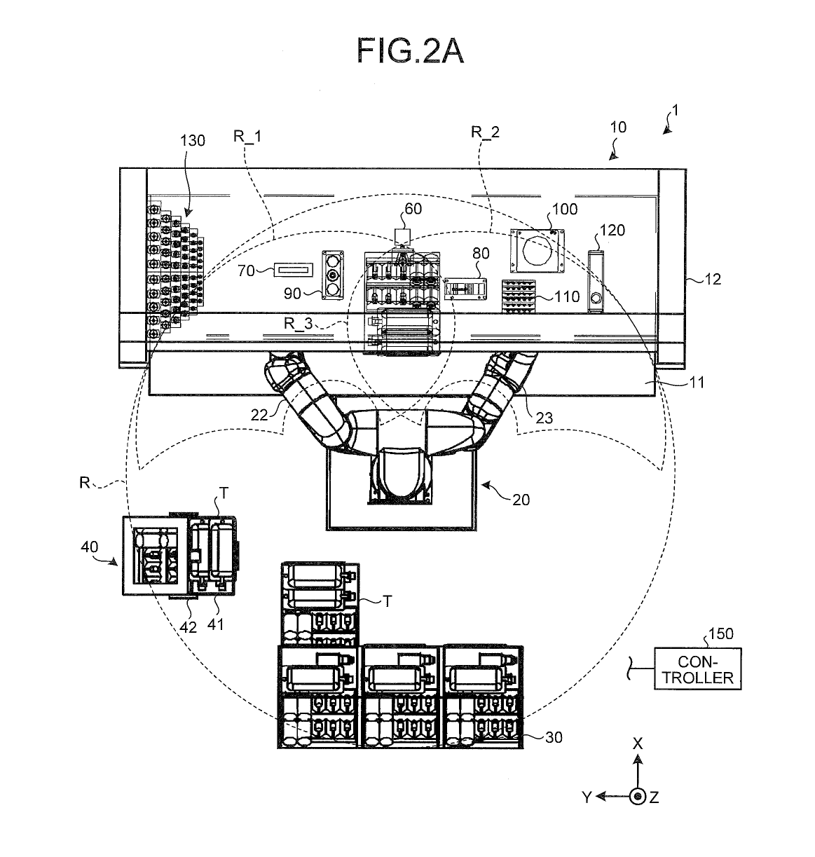

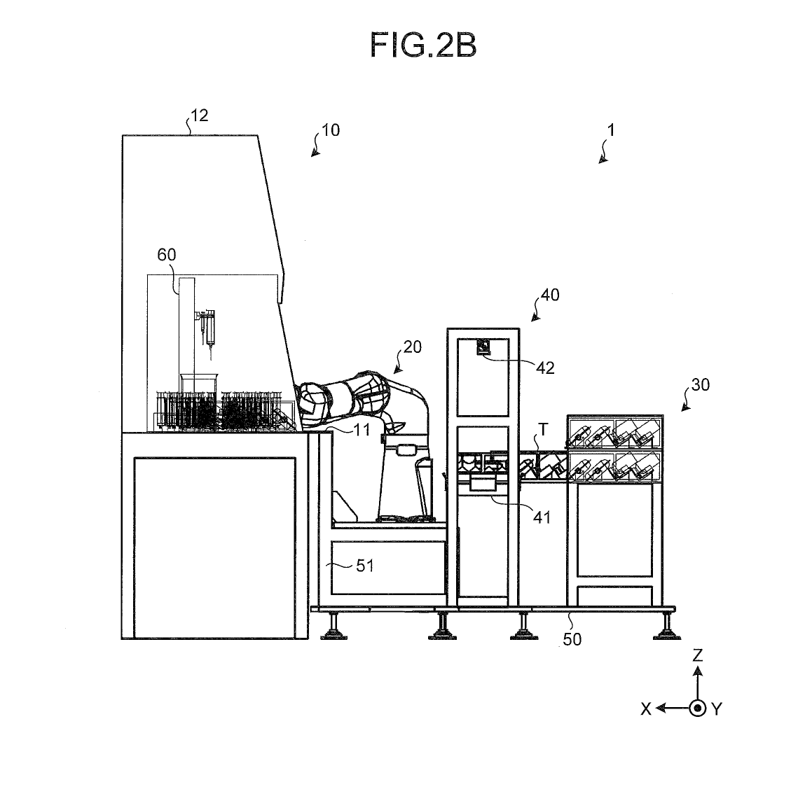

The layout of the automatic preparation system 1 is specifically described with reference to FIGS. 2A and 2B. FIGS. 2A and 2B are a schematic plan view and a schematic side view, respectively, of the automatic preparation system according to the present embodiment.

A range R illustrated in FIG. 2A indicates the maximum swing range of the robot 20, in other words, a range within which the end effectors can reach. The safety cabinet 10, the tray depository 30, and the image-capturing stage 40 are disposed in positions overlapping with the range R.

A range R_1 illustrated in FIG. 2A indicates a range within which the end effector of the left arm 22 can reach when the robot 20 faces the safety cabinet 10. In the same manner, a range R_2 indicates a range within which the end effector of the right arm 23 can reach when the robot 20 faces the safety cabinet 10. A range R_3 is a range in which the range R_1 and the range R_2 overlap with each other.

Among the various devices disposed on the top board 11 of the safety cabinet 10, the needle storage case 70, the vial temporary stand 90, and the spare syringe storage case 130 that are handled only by the left arm 22 are disposed in positions overlapping with the range R_1. The disposal bottle 100, the syringe storage case 110, and the weight scale 120 that are handled only by the right arm 23 are disposed in positions overlapping with the range R_2. The syringe holding jig 60 and the needle temporary stand 80 that are handled by the left arm 22 and the right arm 23 are disposed in positions overlapping with the range R_3.

Thus, the robot 20 can perform the preparation operations while facing the safety cabinet 10, in other words, without swinging the body 21 of the robot 20.

The tray depository 30 and the image-capturing stage 40 are disposed in positions not overlapping with the range R_1 or the range R_2. With this arrangement, the preparation operations performed by the robot 20 in the safety cabinet 10 will not be interrupted by the tray depository 30 or the image-capturing stage 40.

As illustrated in FIG. 2B, the tray depository 30 and the image-capturing stage 40 are installed on a common platform 50, and the robot 20 is also installed on the common platform 50 via a base stand 51. The base stand 51 is fixed to the top board 11 of the safety cabinet 10. With this configuration, the positional relation and the height relation among the safety cabinet 10, the robot 20, the tray depository 30, and the image-capturing stage 40 are precisely determined.

The automatic preparation system 1 includes a controller 150. The controller 150 controls operations of the automatic preparation system 1. The controller 150 is, for example, a computer and includes a control unit and an operation database (DB) (not illustrated). The operation DB is a database for causing the automatic preparation system 1 to perform preparation operations in accordance with the content of an electronic medical record, and stores therein a plurality of pieces of operation information in association with identification information of the electronic medical record. When identification information of an electronic medical record is input, the controller 150 reads out operation information associated with the input identification information, and controls the operations of the automatic preparation system 1 in accordance with the read operation information.

2. Devices in Safety Cabinet

2-1. Syringe Holding Jig

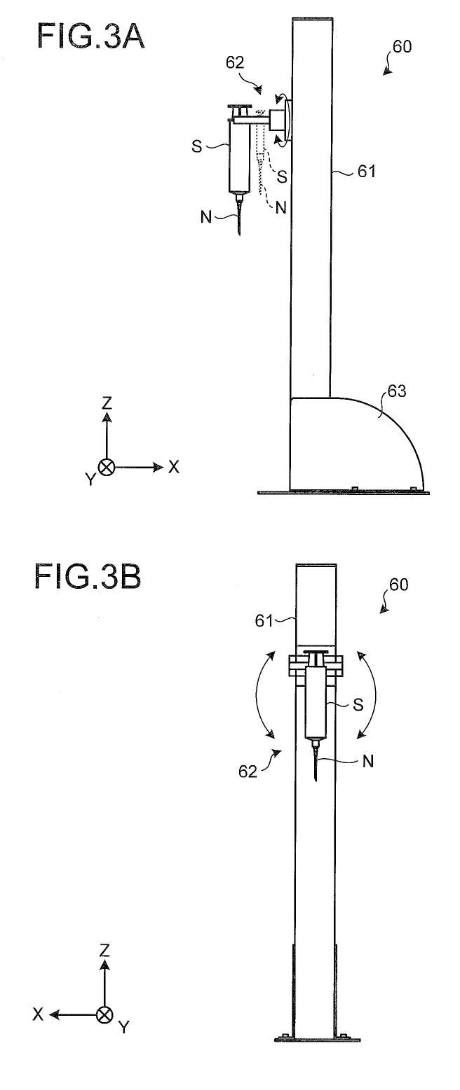

Described next are configurations of the various devices disposed in the safety cabinet 10. First, the configuration of the syringe holding jig 60 is described with reference to FIGS. 3A and 3B. FIGS. 3A and 3B are a schematic side view and a schematic front view, respectively, of the syringe holding jig 60.

As illustrated in FIGS. 3A and 3B, the syringe holding jig 60 includes a support 61, a holder 62 installed on a side surface of the support 61, and an angle adjuster 63 for adjusting the angle of the support 61.

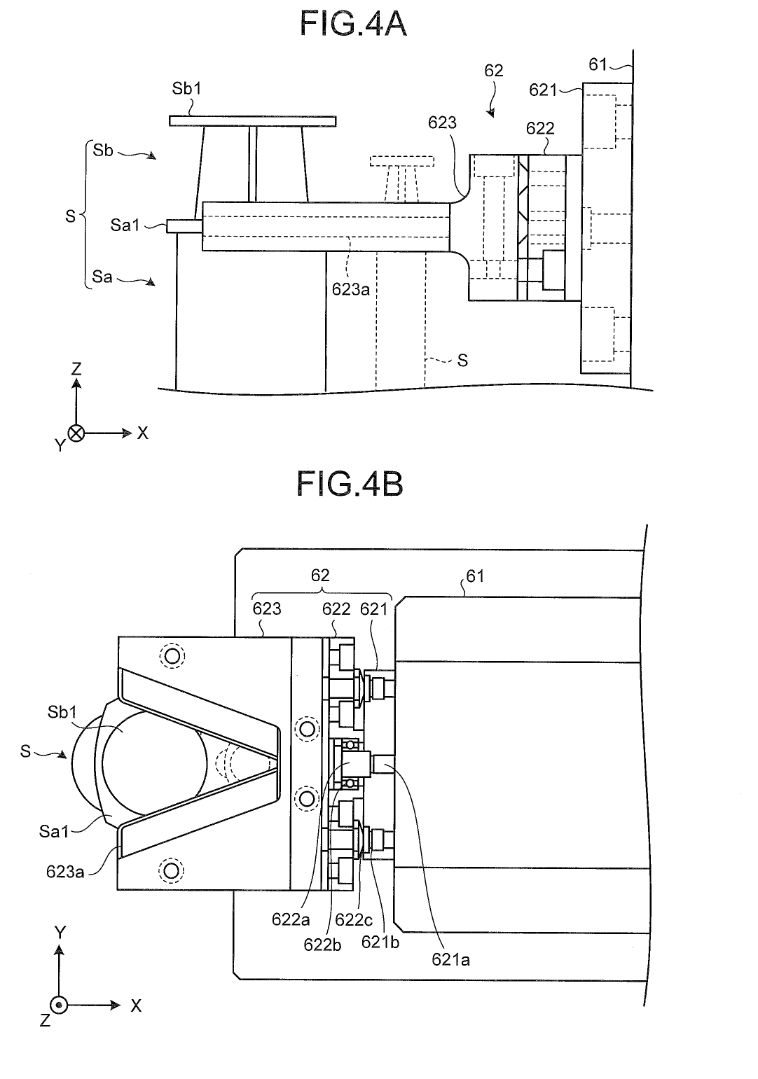

The holder 62 rotatably holds a syringe S. The holder 62 can hold a plurality of types of syringes S that have different diameters. Described herein is a detailed configuration of the holder 62 with reference to FIGS. 4A and 4B. FIGS. 4A and 4B are an enlarged schematic side view and an enlarged schematic plan view, respectively, of the periphery of the holder 62.

As illustrated in FIG. 4A, the holder 62 includes a fixing unit 621, a rotation unit 622, and a main body 623. The base end of the fixing unit 621 is fixed to the support 61, and the leading end thereof supports the rotation unit 622. The base end of the rotation unit 622 is rotatably supported by the fixing unit 621. The base end of the main body 623 is fixed to the leading end of the rotation unit 622, and the leading end of the main body 623 holds a syringe S.

The syringe S includes an outer cylinder Sa and an inner cylinder Sb. The base ends of the outer cylinder Sa and the inner cylinder Sb are formed with a flange Sa1 and a flange Sb1, respectively.

The main body 623 includes a catching part 623a having a slit into which the flange Sa1 of the outer cylinder Sa can be inserted. The flange Sa1 of the outer cylinder Sa is inserted into the slit of the catching part 623a, and the flange Sa1 is caught by the catching part 623a. With this configuration, the syringe S is held by the main body 623.

As illustrated in FIG. 4B, the catching part 623a is formed such that it becomes narrower from the leading end toward the base end of the catching part 623a. With this configuration, the main body 623 can hold a syringe S having a different diameter. In other words, when the diameter of the syringe S is large, the main body 623 can hold the syringe S at a position close to the leading end of the main body 623, and when the diameter of the syringe S is small, the main body 623 can hold the syringe S at a position close to the base end thereof.

The fixing unit 621 includes a shaft 621a extending in the horizontal direction (X-axis direction in FIG. 4B). The rotation unit 622 includes a shaft 622a extending in the horizontal direction (X-axis direction in FIG. 4B). The base end of the shaft 622a of the rotation unit 622 is rotatably supported by a bearing 622b, and the leading end of the shaft 622a is coupled with the shaft 621a of the fixing unit 621. With this configuration, the rotation unit 622 and the main body 623 are rotatably supported by the fixing unit 621 about the horizontal axis.

The fixing unit 621 includes a ball plunger 621b, and the rotation unit 622 includes a ball button 622c. The ball plunger 621b and the ball button 622c determine the position of the main body 623 at which the syringe S is vertically held.

2-2. Needle Storage Case

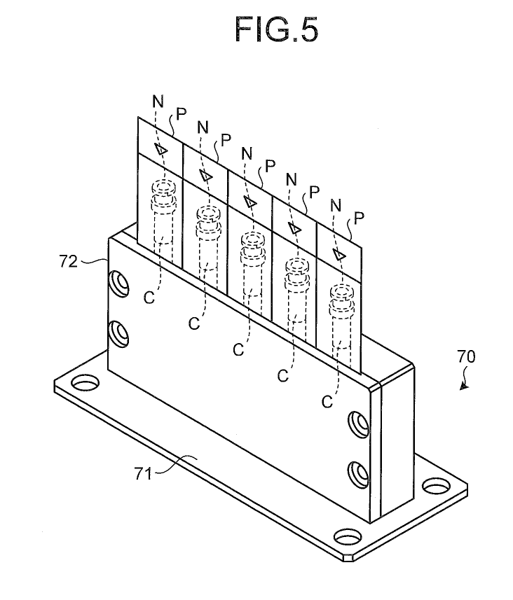

Described next is the configuration of the needle storage case 70 with reference to FIG. 5. FIG. 5 is a schematic perspective view of the needle storage case 70.

As illustrated in FIG. 5, the needle storage case 70 includes a base 71 fixed on the top board 11 of the safety cabinet 10, and a holder 72 that is disposed on the base 71 and that substantially vertically holds needles N by sandwiching a bottom part of the needles N from both sides thereof.

The needles N are held in the needle storage case 70 with caps C on in a packed state in packages P. With this configuration, the needles N can be kept clean immediately before the preparation operations.

2-3. Needle Temporary Stand

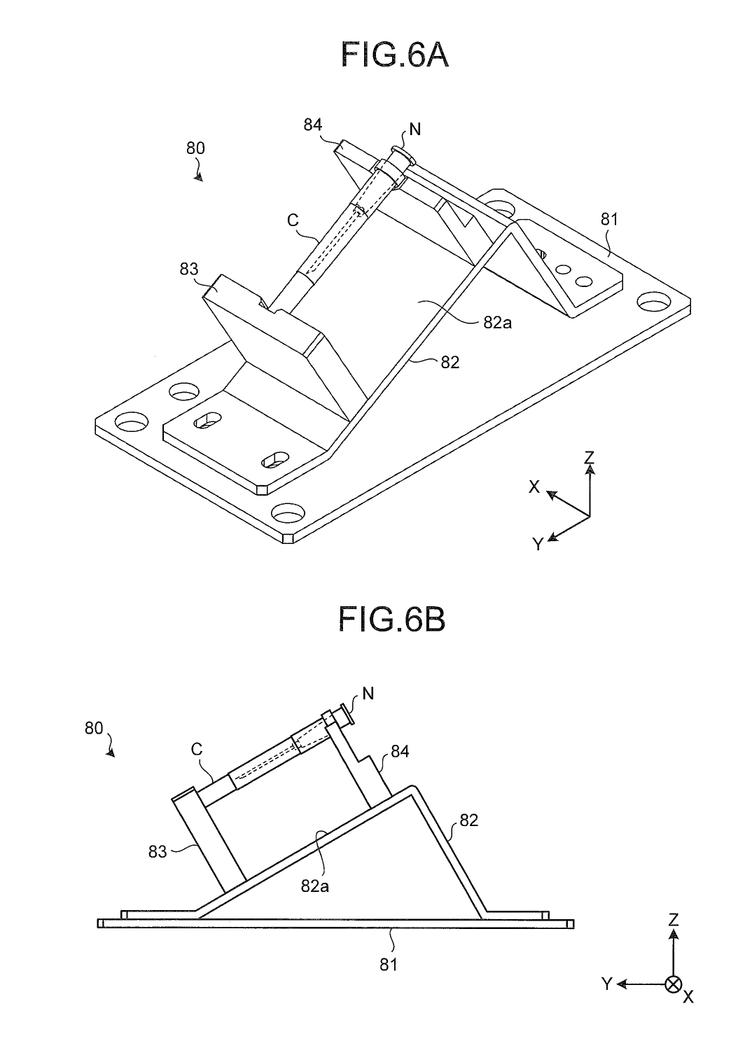

Described next is the configuration of the needle temporary stand 80 with reference to FIGS. 6A and 6B. FIGS. 6A and 6B are a schematic perspective view and a schematic side view, respectively, of the needle temporary stand 80.

As illustrated in FIGS. 6A and 6B, the needle temporary stand 80 includes a base 81 fixed on the top board 11 of the safety cabinet 10 and a tilt stand 82 that is disposed on the base 81 and that includes a tilt surface 82a tilting at a certain angle relative to the board surface (horizontal surface) of the top board 11 of the safety cabinet 10. On the tilt surface 82a of the tilt stand 82, a leading end catching part 83 and a base end catching part 84 are installed in a standing manner with a certain gap therebetween.

The leading end catching part 83 is disposed at a lower side of the tilt surface 82a than the base end catching part 84 and supports the leading end of the cap C. The base end catching part 84 is disposed at an upper side of the tilt surface 82a than the leading end catching part 83 and supports the base end (a side at which an opening is formed) of the cap C. With this configuration, the leading end catching part 83 and the base end catching part 84 support the cap C and the needle N stored in the cap C substantially parallel to the tilt surface 82a of the tilt stand 82 (that is, in a tilted state relative to the top board 11 of the safety cabinet 10) with a certain space from the tilt surface 82a.

3. Configuration of End Effectors

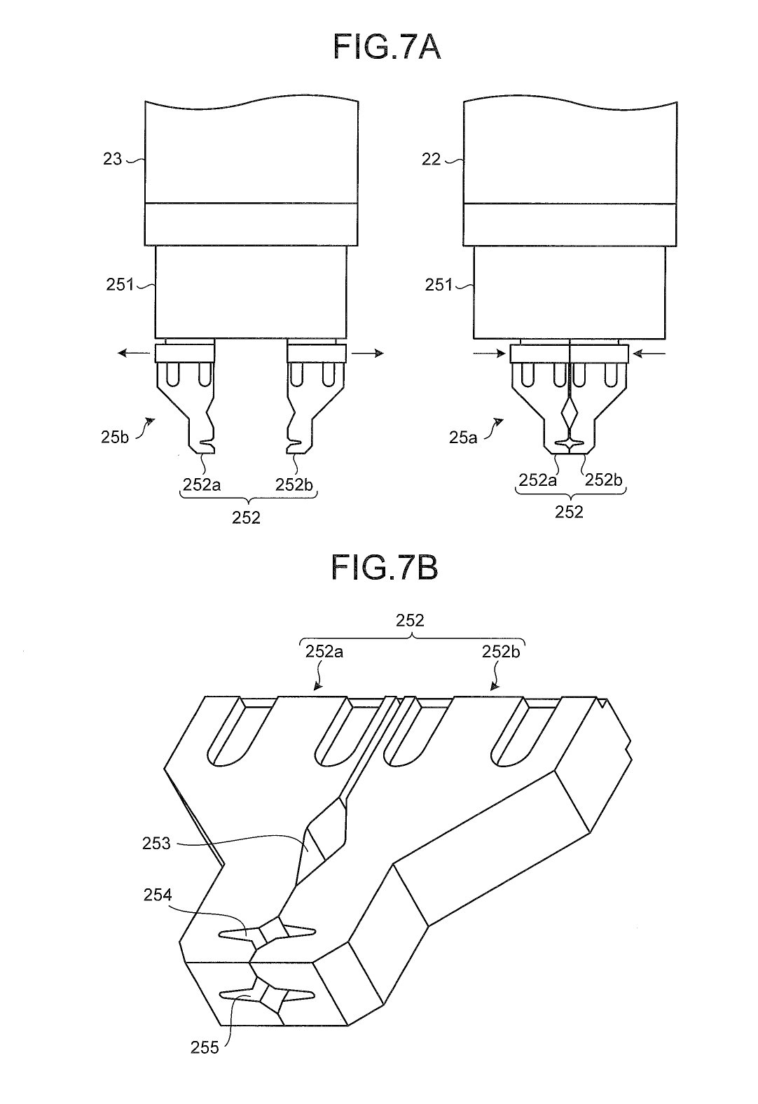

Described next is the configuration of end effectors provided for the robot 20 with reference to FIGS. 7A and 7B. FIG. 7A is a schematic plan view of the end effectors and FIG. 7B is a schematic perspective view of an end effector.

As illustrated in FIG. 7A, end effectors 25a and 25b are provided at the leading ends of the left arm 22 and the right arm 23, respectively. The end effectors 25a and 25b have the same configuration and each include a main body 251 and a holding part 252 including a pair of holding tips 252a and 252b.

The base end of the main body 251 is rotatably supported by the leading end of the left arm 22 (right arm 23), and the leading end thereof supports the base ends of the pair of holding tips 252a and 252b. The main body 251 includes a driving unit that moves the pair of holding tips 252a and 252b closer to and apart from each other along a direction perpendicular to the rotor shaft of the main body 251. The holding part 252 holds an object located between the pair of holding tips 252a and 252b by moving the pair of holding tips 252a and 252b driven by the driving unit of the main body 251.

As illustrated in FIG. 7B, the pair of holding tips 252a and 252b have a symmetrical shape and are formed with a first recessed portion 253, a second recessed portion 254, and a third recessed portion 255 on surfaces facing each other, that is, on holding surfaces.

The first recessed portion 253 is formed in the substantial center of the holding tips 252a and 252b. The first recessed portion 253 is mainly used to hold the outer cylinder Sa (see FIG. 4A) of the syringe S, and is formed in accordance with the shape of the outer cylinder Sa of the syringe S.

The second recessed portion 254 and the third recessed portion 255 are formed in an end portion of the holding tips 252a and 252b. The second recessed portion 254 and the third recessed portion 255 are used to hold the flange Sa1 of the outer cylinder Sa and the flange Sb1 of the inner cylinder Sb, or a flange of the cap C, and are formed in accordance with the shapes of the flanges.

The second recessed portion 254 and the third recessed portion 255 are formed perpendicular to each other. With this configuration, the robot 20 can grasp the syringe S in a perpendicular manner or in a parallel manner relative to the extending direction of the arms 22 and 23. Specifically, the robot 20 can grasp the syringe S along the extending direction of the arms 22 and 23 by using the second recessed portion 254, and can grasp the syringe S perpendicular to the extending direction of the arms 22 and 23 by using the third recessed portion 255.

4. Specific Operations of the Automatic Preparation System

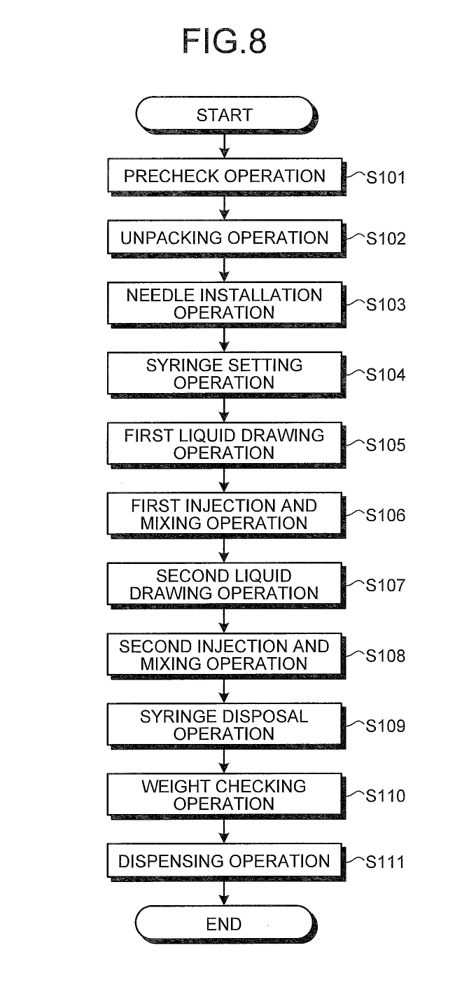

Described next is specific operations of the automatic preparation system 1 with reference to, for example, FIG. 8. FIG. 8 is a flowchart illustrating the procedure of a series of preparation operations performed by the automatic preparation system 1. The automatic preparation system 1 performs the processes illustrated in FIG. 8 under the control of the controller 150 (see FIG. 2A).

4-1. Precheck Operation

As illustrated in FIG. 8, the automatic preparation system 1 performs a precheck operation by using the robot 20 and the image-capturing stage 40 (Step S101). In the precheck operation, the robot 20 takes out a tray T from the tray depository 30 by using the left arm 22 or the right arm 23 in accordance with the control of the controller 150, and puts the tray T that has been taken out on the temporary stand 41 of the image-capturing stage 40.

When the tray T is put on the temporary stand 41, the image-capturing unit 42 provided above the temporary stand 41 reads out a barcode attached to the tray T, and transmits the read data to the controller 150. The controller 150 determines whether the right tray T has been selected by comparing the data received from the image-capturing unit 42 with stored data.

If the controller 150 determines that the right tray T has been selected, the robot 20 conveys the tray T put on the temporary stand 41 into the safety cabinet 10, and puts the tray T on the top board 11. If not, the controller 150 cancels the series of preparation operations.

As described above, the automatic preparation system 1 performs the precheck operation for determining whether the right tray T has been selected before performing the preparation operations inside the safety cabinet 10. In other words, the robot 20 takes out a tray T from the tray depository 30 and puts the tray T on the temporary stand 41 of the image-capturing stage 40. The image-capturing unit 42 of the image-capturing stage 40 captures an image of the tray T put on the temporary stand 41. Even when a wrong tray T is selected, the precheck operation can prevent a preparation error and can prevent the medications from being wasted.

Although described above is an example in which the tray T is distinguished by a barcode, the tray T may be distinguished by using other methods than barcodes. For example, the automatic preparation system 1 may implement image recognition to distinguish a tray T, not by using barcodes.

4-2. Unpacking Operation

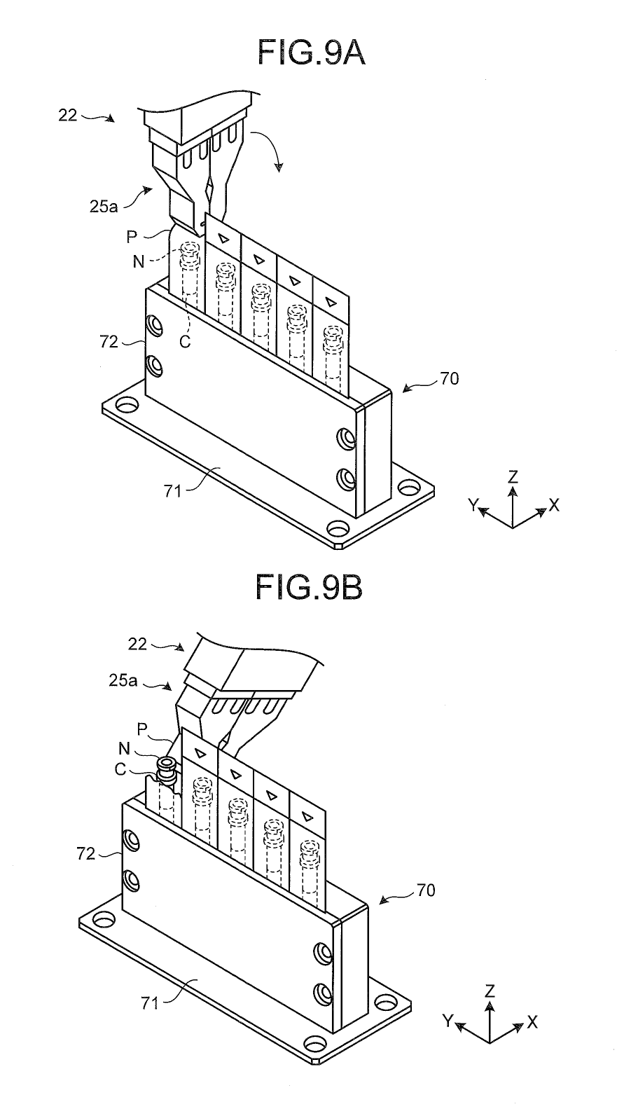

Subsequently, in the automatic preparation system 1, the robot 20 performs an unpacking operation of a needle N (see FIG. 5) held by the needle storage case 70 (Step S102). Described here is an example of how the unpacking operation is performed with reference to FIGS. 9A and 9B. FIGS. 9A and 9B are diagrams illustrating how the unpacking operation is performed.

As illustrated in FIG. 9A, needles N are held in the needle storage case 70 with caps C on and in a packed state in packages P. The robot 20 unpacks a packed needle N by using the left arm 22 thereof.

Specifically, the robot 20 uses the end effector 25a to hold an upper portion of a package P from above (see FIG. 9A), and tilts the left arm 22 towards the robot 20. By this movement, because the bottom portion of the needle N is held by the holder 72, the needle N is caught in the package P and tears the package P (see FIG. 9B). The needle N is thus unpacked.

The robot 20 grasps the cap C including the needle N from a side thereof by using the end effector 25a, and takes out the cap C held by the end effector 25a from the needle storage case 70 and puts it on the needle temporary stand 80 (see FIG. 6A).

As described above, in the automatic preparation system 1, the needle N is held in the needle storage case 70 in a packed state, and the robot 20 unpacks the packed needle N by using both arms 22 and 23 in a cooperative manner. With this configuration, the needle N can be unpacked automatically and can be kept clean immediately before the preparation operations.

Although described above is an example in which the robot 20 performs the unpacking operation by using the left arm 22, the robot 20 may perform the unpacking operation by using the right arm 23. In this case, the needle storage case 70 may be disposed in the range R_2 (see FIG. 2A) within which the end effector 25b of the right arm 23 can reach.

4-3. Needle Installation Operation

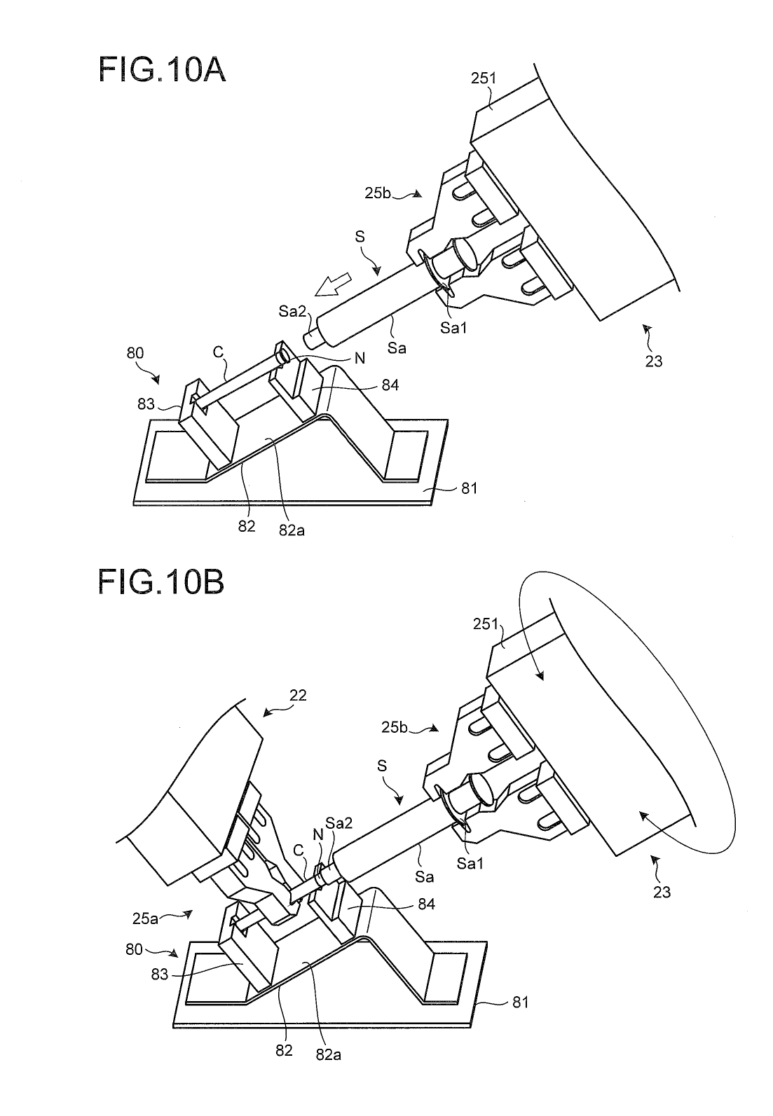

Subsequently, in the automatic preparation system 1, the robot 20 performs a needle installation operation (Step S103). In the needle installation operation, the robot 20 installs the needle N to the syringe S. Described here is an example of how the needle installation operation is performed with reference to FIGS. 10A and 10B. FIGS. 10A and 10B are diagrams illustrating how the needle installation operation is performed.

The robot 20 takes out one syringe S from the syringe storage case 110 (see FIG. 2A) by using the end effector 25b of the right arm 23. Specifically, the robot 20 grasps the syringe S from above by sandwiching the flange Sa1 (see FIG. 4A) formed on the outer cylinder Sa of the syringe S with the second recessed portion 254 (see FIG. 7B) of the end effector 25b and picks it up from the syringe storage case 110.

The pick-up operation of the syringe may be performed simultaneously with the unpacking operation at Step S102. In other words, the robot 20 may perform the unpacking operation by using the left arm 22 while performing the pick-up operation of the syringe by using the right arm 23. The robot 20 can perform a series of preparation operations efficiently by using both arms 22 and 23.

As illustrated in FIG. 10A, the robot 20 positions the leading end of the syringe S held by the end effector 25b at the position of the base end of the needle N placed on the needle temporary stand 80. Although not illustrated in FIG. 10A, the end effector 25a of the left arm 22 grasps the outer cylinder Sa of the syringe S while the robot 20 is performing the positioning described above, whereby the robot 20 can accurately perform the positioning of the syringe S and the needle N.

After performing the positioning of the syringe S and the needle N, the robot 20 grasps the cap C by using the end effector 25a of the left arm 22 and rotates the main body 251 of the end effector 25b of the right arm 23 while holding the cap C (see FIG. 10B). By this operation, the syringe S is rotated and the needle N is installed to a leading end Sa2 of the syringe S. The robot 20 then pulls the syringe S back along the longitudinal direction thereof and takes out the needle N installed to the syringe S from the cap C.

As described above, in the automatic preparation system 1, the robot 20 takes out a needle N from the needle storage case 70 and sets it on the needle temporary stand 80. The robot 20 then operates both arms 22 and 23 in a cooperative manner to perform the needle installation operation by which the needle N set on the needle temporary stand 80 is installed to the syringe S taken out from the syringe storage case 110. With this configuration, the needle N can be automatically installed to the syringe S.

The automatic preparation system 1 includes the needle temporary stand 80 that holds the needle N in a tilted state relative to the top board 11. With this configuration, the robot 20 can easily perform the needle installation operation.

The needle temporary stand 80 supports the leading end and the base end of the cap C by the leading end catching part 83 and the base end catching part 84 disposed on the tilt stand 82, respectively, thereby supporting the cap C and the needle N with a certain space from the tilt surface 82a. With this configuration, the robot 20 can easily put the cap C and the needle N on the needle temporary stand 80 and easily take out the cap C and the needle N from the needle temporary stand 80.

The cap C remains on the needle temporary stand 80 and will be used again in a syringe disposal operation to be described later.

4-4. Syringe Setting Operation

Subsequently, in the automatic preparation system 1, the robot 20 performs a syringe setting operation in which the syringe S fitted with the needle N is set on the syringe holding jig 60 (Step S104).

The robot 20 passes the syringe S held by the end effector 25b of the right arm 23 to the end effector 25a of the left arm 22. The robot 20 grasps the tubular part of the outer cylinder Sa by using the end effector 25a.

Subsequently, the robot 20 attaches the syringe S held by the end effector 25a to the holder 62 of the syringe holding jig 60 so that the holder 62 holds the syringe S. Specifically, the robot 20 puts the flange Sa1 of the outer cylinder Sa into the catching part 623a (FIG. 4A) formed on the main body 623 of the holder 62 so that the catching part 623a catches the flange Sa1, and the holder 62 holds the syringe S. The robot 20 puts the syringe S into the holder 62 with the needle N pointed up so that the holder 62 holds the syringe S in this position.

4-5. First Liquid Drawing Operation

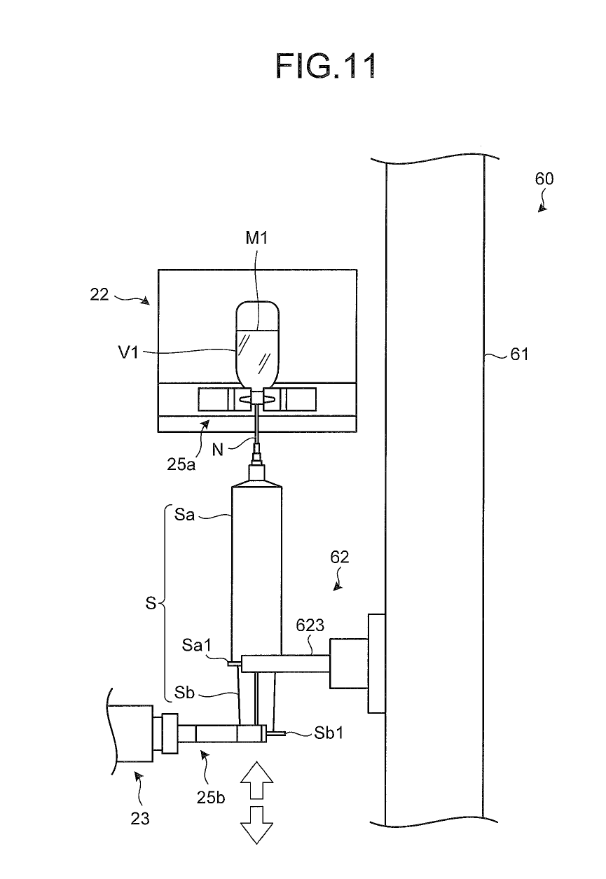

Subsequently, in the automatic preparation system 1, the robot 20 performs a first liquid drawing operation in which a medication contained in a vial is drawn into the syringe S by using both arms 22 and 23 and the syringe holding jig 60 (Step S105). Described here is an example of how the first liquid drawing operation is performed with reference to FIG. 11. FIG. 11 is a diagram illustrating how the first liquid drawing operation is performed.

As illustrated in FIG. 11, the robot 20 takes out a vial V1 from the tray T by using the end effector 25a of the left arm 22. The robot 20 pricks a stopper (for example, a rubber stopper) of the vial V1 on the needle N of the syringe S held by the syringe holding jig 60 with the needle N pointed up so that the needle N is inserted into the stopper of the vial V1. Although not illustrated in FIG. 11, the end effector 25b of the right arm 23 grasps the outer cylinder Sa of the syringe S while the robot 20 is performing the above-described operation, whereby the robot 20 can precisely insert the needle N into the stopper of the vial V1.

The robot 20 then grasps the inner cylinder Sb of the syringe S by using the end effector 25b of the right arm 23. Specifically, the robot 20 grasps the inner cylinder Sb by sandwiching the flange Sb1 formed on the inner cylinder Sb with the third recessed portion 255 (see FIG. 7B) of the end effector 25b of the right arm 23.

The robot 20 moves the end effector 25b holding the inner cylinder Sb upwards and downwards by using the right arm 23 to adjust the pressure inside the vial V1, and causes the syringe S to draw out a medication M1 contained in the vial V1.

Specifically, after holding the inner cylinder Sb with the end effector 25b, the robot 20 moves the inner cylinder Sb downwards by using the right arm 23 before the robot 20 pricks the vial V1 on the needle N. By this operation, air is introduced into the syringe S. After pricking the vial V1 on the needle N, the robot 20 moves the inner cylinder Sb downwards by using the right arm 23, whereby the medication M1 in the vial V1 is drawn into the syringe S to a certain amount. The robot 20 then moves the inner cylinder Sb upwards by using the right arm 23, so that the air inside the syringe S is supplied into the vial V1.

The robot 20 repeats the operation of drawing out the medication M1 in the vial V1 and the operation of supplying the air in the syringe S into the vial V1 alternately, thereby drawing out all the medication M1 in the vial V1 into the syringe S.

As described above, in the automatic preparation system 1, the robot 20 operates the left arm 22 to hold the vial V1 containing the medication M1, and pricks the vial V1 on the needle N. The robot 20 then operates the right arm 23 to hold the inner cylinder Sb of the syringe S and moves the inner cylinder Sb, thereby performing the first liquid drawing operation in which the medication M1 contained in the vial V1 is drawn into the syringe S. With this configuration, the automatic preparation system 1 can automatically perform the first liquid drawing operation.

In the automatic preparation system 1, the robot 20 causes the syringe S to draw out the medication contained in the vial V1 while adjusting the pressure inside the vial V1, whereby the robot 20 can perform the liquid drawing operation appropriately.

The robot 20 puts the used vial V1 on, for example, the vial temporary stand 90.

4-6. First Injection and Mixing Operation

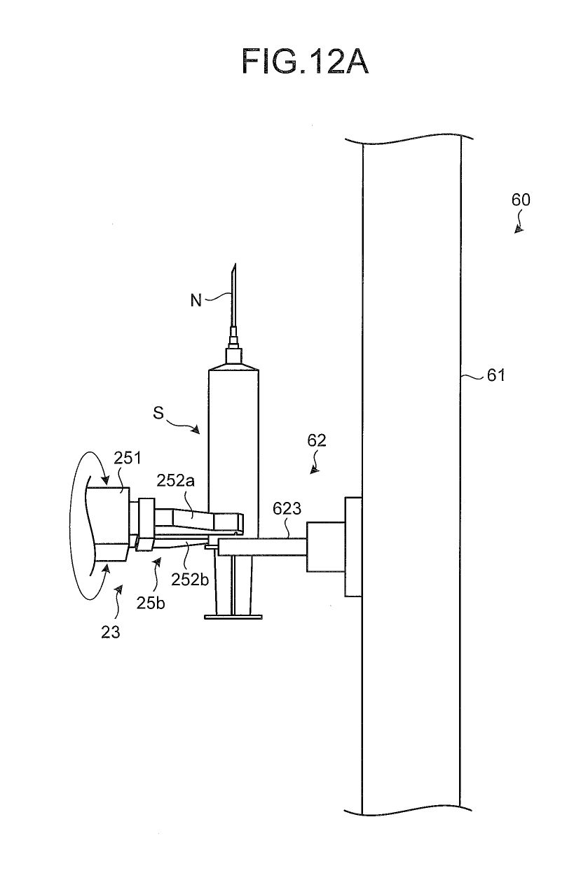

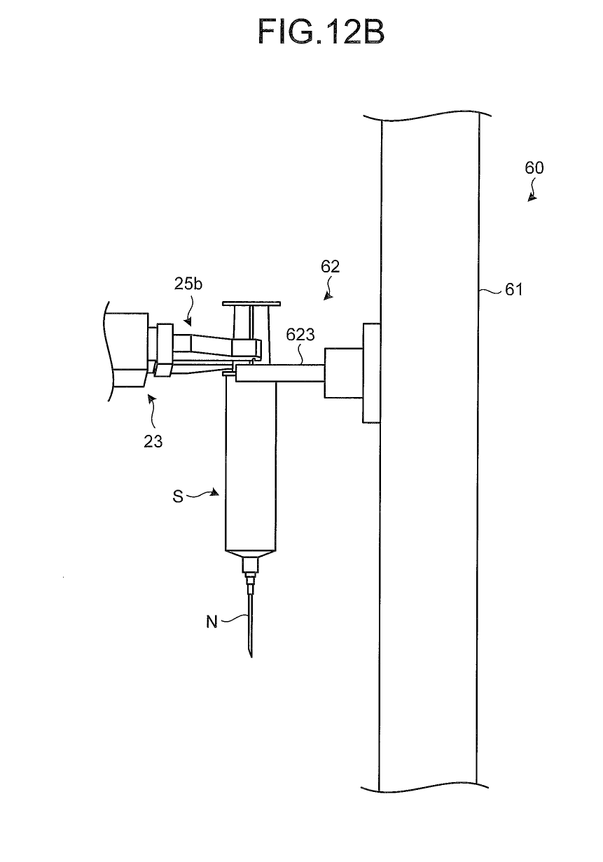

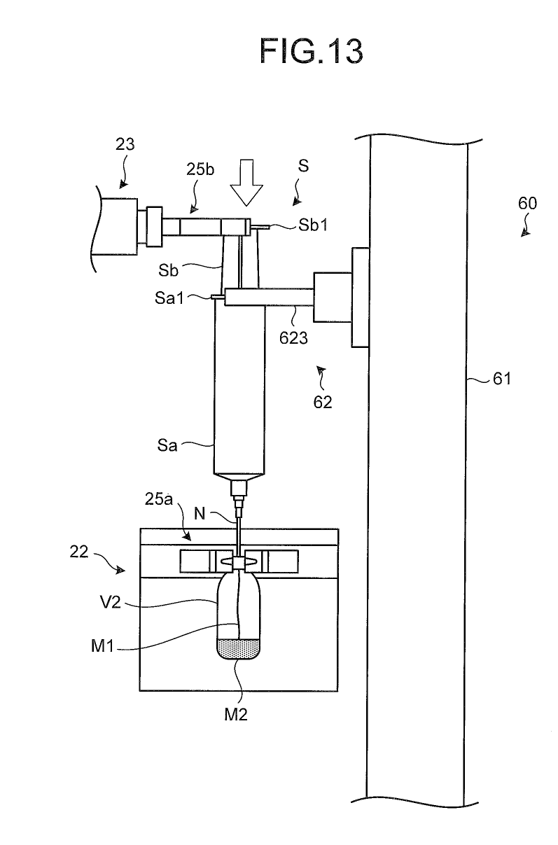

Subsequently, in the automatic preparation system 1, the robot 20 performs a first injection and mixing operation in which the medication M1 drawn into the syringe S is mixed with another medication M2 (Step S106). Described here is an example of how the first injection and mixing operation is performed with reference to FIGS. 12A, 12B, and 13. FIGS. 12A and 12B are diagrams illustrating an inversion operation and FIG. 13 is a diagram illustrating how the first injection and mixing operation is performed.

The robot 20 first inverts the syringe S by using the end effector 25b of the right arm 23. Specifically, as illustrated in FIG. 12A, the robot 20 widens the pair of holding tips 252a and 252b of the end effector 25b to a certain width and moves the end effector 25b so that the holding tip 252a abuts the upper surface of the main body 623 and the holding tip 252b abuts the lower surface of the main body 623. In this state, the robot 20 rotates the main body 251 of the end effector 25b by 180 degrees.

By this operation, the rotation unit 622 and the main body 623 of the holder 62 rotate by 180 degrees relative to the fixing unit 621, so that the syringe S held by the main body 623 is inverted (see FIG. 12B). Consequently, the syringe S is held by the holder 62 with the needle N pointed down.

The robot 20 takes out a vial V2 from the tray T by using the end effector 25a of the left arm 22. The vial V2 contains the medication M2 that is different from the medication M1 contained in the vial V1. Assume that the medication M2 is a powder medication.

The robot 20 pricks the stopper of the vial V2 on the needle N of the syringe S held by the syringe holding jig 60 with the needle N pointed down so that the needle N is inserted into the stopper of the vial V2.

The robot 20 grasps the inner cylinder Sb of the syringe S by using the end effector 25b of the right arm 23. Specifically, the robot 20 grasps the inner cylinder Sb by sandwiching the flange Sb1 formed on the inner cylinder Sb with the third recessed portion 255 (see FIG. 7B) of the end effector 25b.

The robot 20 moves the end effector 25b downwards that grasps the inner cylinder Sb by using the right arm 23 and injects the medication M1 contained in the syringe S into the vial V2. By this operation, the medication M1 and medication M2 are contained in the vial V2.

As described above, in the automatic preparation system 1, the robot 20 performs the first injection and mixing operation in which the robot 20 operates the right arm 23 to hold the vial V2 containing the medication M2 and pricks the vial V2 on the needle N, and operates the left arm 22 to hold the inner cylinder Sb of the syringe S and moves the inner cylinder Sb, thereby injecting the medication M1 in the syringe S into the vial V2. With this configuration, the automatic preparation system 1 can automatically perform the first injection and mixing operation.

The robot 20 may push the inner cylinder Sb to the bottom and slightly pull it up, and push it again to the bottom so that the medication M1 will remain in the syringe S as little as possible.

Subsequently, the robot 20 shakes the left arm 22 to agitate the vial V2 held by the end effector 25a, so that the medication M1 and the medication M2 in the vial V2 are mixed. As described above, in the automatic preparation system 1, the robot 20 performs the mixing operation, whereby the different medications M1 and M2 in the vial V2 can be mixed. The mixing operation is set to such an extent to which the medications M1 and M2 in the vial V2 will not make bubble.

While performing the mixing operation described above by using the left arm 22, the robot 20 inverts the syringe S by using the right arm 23. By this inversion operation, the syringe S is held in a position illustrated in FIG. 11 again, in other words, the syringe S is held with the needle N pointed up.

4-7. Second Liquid Drawing Operation

Subsequently, in the automatic preparation system 1, the robot 20 performs a second liquid drawing operation in which the mixture of the medication M1 and the medication M2 contained in the vial V2 is drawn into the syringe S (Step S107). The second liquid drawing operation is performed in the same manner as in the first liquid drawing operation.

4-8. Second Injection and Mixing Operation

Subsequently, in the automatic preparation system 1, the robot 20 performs a second injection and mixing operation in which the mixture of the medication M1 and the medication M2 drawn into the syringe S is mixed with a medication (intravenous solution product) contained in the intravenous solution bag (Step S108).

The second injection and mixing operation is performed in basically the same manner as in the first injection and mixing operation described above. In other words, the robot 20 first inverts the syringe S by using the end effector 25b of the right arm 23. The robot 20 also takes out the intravenous solution bag from the tray T by using the end effector 25a of the left arm 22. The intravenous solution bag contains an intravenous solution product containing substances such as a physiological saline solution and grape sugar.

The robot 20 injects the mixture in the syringe S into the intravenous solution bag in the same manner as in the first injection and mixing operation described above. By this operation, the preparation of medication is completed.

The robot 20 puts the used vial V2 on, for example, the vial temporary stand 90.

4-9. Syringe Disposal Operation

Subsequently, in the automatic preparation system 1, the robot 20 performs a syringe disposal operation in which the used syringe S is disposed of in the disposal bottle 100 (see FIG. 2A) (Step S109). Specifically, the robot 20 removes the syringe S from the syringe holding jig 60 by using the right arm 23, and conveys the removed syringe S to the needle temporary stand 80. The robot 20 then puts the needle N into the cap C placed on the needle temporary stand 80, and disposes of the syringe S into the disposal bottle 100.

As described above, in the automatic preparation system 1, after the preparation operations are completed, the robot 20 removes the used syringe S from the syringe holding jig 60 and puts the cap C placed on the needle temporary stand 80 on the needle N, and disposes of the syringe S into the disposal bottle 100. In other words, the robot 20 disposes of the used syringe S with the cap C on the needle N, whereby used syringes S can be safely collected by an operator.

Although described here is an example in which the robot 20 disposes of the syringe S with the needle N installed thereon, the robot 20 may remove the needle N from the syringe S by using the needle temporary stand 80 and dispose of the syringe S and the needle N with the cap C on separately. In this case, two disposal bottles 100 may be provided in the safety cabinet 10.

4-10. Weight Checking Operation

Subsequently, in the automatic preparation system 1, the robot 20 performs a weight checking operation in which the weight of the prepared medication is measured with the weight scale 120 (Step S110). Specifically, the robot 20 puts the intravenous solution bag held by the end effector 25a of the left arm 22 on the weight scale 120. The measurement result of the weight scale 120 is transmitted to the controller 150 and the controller 150 determines whether the intravenous solution bag has an appropriate weight.

4-11. Dispensing Operation

Subsequently, in the automatic preparation system 1, the robot 20 performs a dispensing operation in which the prepared medication is dispensed (Step S111). In other words, the robot 20 stores the intravenous solution bag containing the prepared medication into the tray T, and puts the tray T back to the tray depository 30. When the dispensing operation is completed, the automatic preparation system 1 finishes the series of preparation operations.

In the dispensing operation, the robot 20 may attach a label on which information such as the name of a patient is written on the intravenous solution bag.

As described above, the automatic preparation system 1 according to the present embodiment includes the safety cabinet 10, the robot 20, and the syringe holding jig 60. The robot 20 is disposed near the safety cabinet 10 and includes the arms 22 and 23. The syringe holding jig 60 is provided in the safety cabinet 10 and rotatably holds a syringe S. The robot 20, after taking out the syringe S from a certain syringe storage case 110 and attaching the syringe S to the jig 60, operates the arms 22 and 23 in a cooperative manner to perform the preparation of a medication using the syringe S.

The automatic preparation system 1 according to the present embodiment can efficiently perform the preparation operations of medications. The automatic preparation system 1 according to the present embodiment can automatically perform a series of preparation operations.

Although, in the embodiment above, described is an example in which the safety cabinet is used as a work table, the work table is not limited to the safety cabinet, but may be, for example, a clean bench. Depending on the type of medications to be prepared, a simple work table that does not include the case 12 can be used.

Although, in the embodiment above, described is an example in which a vial is used as a medication container, the medication container is not limited to the vial, but may be a container, such as an ampule, an intravenous solution bag, or a bottle, that can contain a medication in a sealed state.

Although, in the embodiment above, described is an example in which the robot 20 is a dual-arm robot having the left arm 22 and the right arm 23, the robot 20 may have three or more arms.

The configuration of the syringe holding jig is not limited to the configuration described in the embodiment above. For example, the main body of the syringe holding jig may include a pair of holding tips that sandwich the syringe from both sides thereof. With this configuration, the position of the center axis of the syringe held by the syringe holding jig will not deviate when the diameter of the syringe varies.

The nature of the series of preparation operations is not limited to what is described in the embodiment above. Although the embodiment above describes, for example, an example in which the robot 20 mixes a liquid medication and a powder medication, the robot 20 can mix a liquid medication and another liquid medication. In this case, the robot 20 does not necessarily perform the shaking operation described above.

Although, in the embodiment above, the first liquid drawing operation and the first injection and mixing operation are each performed once, the automatic preparation system can mix three or more types of medications by performing the first liquid drawing operation and the first injection and mixing operation a plurality of times.

Although the embodiment above describes an example in which the robot injects the prepared medication in an intravenous solution bag (medication container) and dispenses it, the robot may put the prepared medication in a syringe and dispense it. For example, the automatic preparation system may sequentially perform the first liquid drawing operation several times with respect to a plurality of medications of different kinds, put a cap placed on the needle temporary stand on the needle, and put the syringe on the tray to dispense it.

Additional advantages and modifications will readily occur to those skilled in the art. Therefore, the invention in its broader aspects is not limited to the specific details and representative embodiments illustrated and described herein. Accordingly, various modifications may be made without departing from the spirit or scope of the general inventive concept as defined by the appended claims and their equivalents.

What is claimed is:

1. An automatic preparation system comprising:
a work table;
a robot disposed near the work table and including a plurality of arms; and
a jig provided on the work table and rotatably holding a syringe, wherein
the robot, after taking out the syringe from a syringe storage case and attaching the syringe to the jig, operates the arms in a cooperative manner to perform a preparation of a medication using the syringe.

2. The automatic preparation system according to claim 1, wherein
the syringe is held on the jig with a needle pointed up, the needle being installed on a leading end of the syringe, and
the robot grasps a first medication container containing a first medication and pricks the first medication container on the needle by using a first arm of the arms, and grasps an inner cylinder of the syringe and moves the inner cylinder by using a second arm of the arms, to perform a liquid drawing operation in which the first medication contained in the first medication container is drawn into the syringe.

3. The automatic preparation system according to claim 2, wherein
the robot moves the inner cylinder downwards to introduce air into the syringe before pricking the first medication container on the needle, and
the robot draws the first medication contained in the first medication container into the syringe while adjusting pressure inside the first medication container by using the air after pricking the first medication container on the needle.

4. The automatic preparation system according to claim 2, wherein the robot grasps a second medication container containing a second medication and pricks the second medication container on the needle by using one of the first and second arms, and grasps the inner cylinder of the syringe and moves the inner cylinder by using the other of the first and second arms, to perform an injection and mixing operation in which the first medication in the syringe is injected into the second medication container.

5. The automatic preparation system according to claim 4, wherein the robot inverts the syringe rotatably held on the jig by using one of the first and second arms before performing the injection and mixing operation.

6. The automatic preparation system according to claim 5, wherein the robot shakes the first arm or the second arm that grasps the second medication container to agitate the first and second medications contained in the second medication container after performing the injection and mixing operation.

7. The automatic preparation system according to claim 1, wherein
the work table is provided with a needle storage case that holds a plurality of needles, and a needle temporary stand that holds a needle taken out from the needle storage case, and
the robot, after taking out the needle from the needle storage case and setting the needle on the needle temporary stand, operates the arms in a cooperative manner to perform a needle installation operation in which the needle set on the needle temporary stand is installed to the syringe taken out from the syringe storage case.

8. The automatic preparation system according to claim 7, wherein
the needles are held in the needle storage case in a packed state, and
the robot operates the arms in a cooperative manner to perform an unpacking operation of the packed needles.

9. The automatic preparation system according to claim 7, wherein the needle temporary stand holds the needle in a tilted state relative to the work table.

10. The automatic preparation system according to claim 8, wherein the needle temporary stand holds the needle in a tilted state relative to the work table.

11. The automatic preparation system according to claim 7, wherein
the needles are held in the needle storage case with caps on and in a packed state, and
the robot takes out one of the needles, with the cap still on, from the needle storage case and puts the needle on the needle temporary stand, and, after completing the preparation, removes the syringe after use from the jig, puts the cap placed on the needle temporary stand on the needle of the removed syringe, and disposes of the syringe in a disposal place.

12. The automatic preparation system according to claim 1, wherein
the work table is provided with a weight scale, and
the robot performs a weighing operation in which weight of the medication after the preparation is measured with the weight scale.

13. The automatic preparation system according to claim 1, wherein the jig is disposed in an area in which respective movable ranges of the arms overlap with each other in a state where the robot faces the work table.

14. The automatic preparation system according to claim 1, further comprising:
a tray depository on which a tray is placed, the tray storing a plurality of medication containers each containing a different kind of a medication, wherein
the robot, before performing the preparation, takes out the tray from the tray depository and conveys the tray to the work table.

15. The automatic preparation system according to claim 14, further comprising:
an image-capturing stage that includes a temporary stand for the tray and an image-capturing unit provided above the temporary stand, wherein
the robot, after taking out the tray from the tray depository, puts the tray on the temporary stand of the image-capturing stage, and
the image-capturing unit captures an image of the tray put on the temporary stand.

16. The automatic preparation system according to claim 15, wherein the tray depository and the image-capturing stage are disposed at positions at which respective movable ranges of the arms do not overlap with the tray depository and the image-capturing stage in a state where the robot faces the work table.

17. An automatic preparation system comprising:
a work table;
a robot disposed near the work table and including a plurality of arms; and
means for rotatably holding a syringe, wherein
the robot, after taking out the syringe from a syringe storage case and attaching the syringe to the means for holding, operates the arms in a cooperative manner to perform a preparation of a medication using the syringe.
